(19) United States
(12) Patent Application Publication
(10) Pub. No.: US 2026/0100541 A1
(43) Pub. Date: Apr. 9, 2026

(54) UTILIZING A BACK SHELL ASSEMBLY ON MULTIPLE CONNECTORS

(71) Applicant: Textron Systems Corporation, Hunt Valley, MD (US)

(72) Inventors: Robert Allen Shelly, Jr., Shrewsbury, PA (US); Charles David Haskin, II, Taneytown, MD (US); Adam Ross Ferreira, Red Lion, PA (US); Edward Charles Volz, Rosedale, MD (US)

(21) Appl. No.: 19/348,215

(22) Filed: Oct. 2, 2025

Related U.S. Application Data
(60) Provisional application No. 63/703,533, filed on Oct. 4, 2024.

(51) Int. Cl. H01R 13/6581; H01R 13/518; H01R 43/18

(52) U.S. Cl. CPC H01R 13/6581; H01R 13/518; H01R 43/18

(57) ABSTRACT

An electronic connection apparatus includes a first connector, a second connector, and a back shell assembly which has a first back shell constructed and arranged to fit around a portion of the first connector, a second back shell constructed and arranged to fit around a portion of the second connector, and hardware constructed and arranged to fasten the first back shell and the second back shell together. The first back shell and the second back shell provide electromagnetic interference (EMI) shielding to the first connector and the second connector when the first back shell is fit around the portion of the first connector, the second back shell is fit around the portion of the second connector, and the hardware fastens the first back shell and the second back shell together.

### CROSS REFERENCE TO RELATED APPLICATIONS

This application is a regular utility application based on earlier-filed U.S. Application No. 63/703,533 filed on October 4, 2024, entitled "Connector Assembly with EMI Shielding Back Shell Housing Multiple Connectors", the contents and teachings of which are hereby incorporated by reference in their entirety.

### TECHNICAL FIELD

This disclosure relates generally to the field of electronic packaging and electromagnetic interference (EMI) shielding and more specifically to connectors and cables in which is it advantageous to have EMI shielding.

### BACKGROUND

In electronics, connectors can join cables to equipment. For example, a signal connector can join a signal cable to equipment. As another example, a power connector can join a power cable to the same equipment.

In some situations, it may be useful to attach a back shell device around a connector for protection (e.g., for EMI shielding, strain relief, combinations thereof, etc.). Along these lines, a first individual back shell device, which is dimensioned to fully fit around the signal connector, may be attached around the signal connector. As another example, a second individual back shell device, which is dimensioned to fully fit around the power connector, may be separately attached around the power connector.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a first perspective view of an electronic environment which utilizes a back shell assembly in accordance with one or more embodiments.

FIG. 2 is a second perspective view of the electronic environment which utilizes the back shell assembly in accordance with one or more embodiments.

FIG. 3 is a third perspective view of the electronic environment which utilizes the back shell assembly in accordance with one or more embodiments.

FIG. 4 is a perspective view of an electronic connection apparatus which utilizes the back shell assembly in accordance with one or more embodiments.

FIG. 5 is another perspective view of the electronic connection apparatus which utilizes the back shell assembly in accordance with one or more embodiments.

FIG. 6 is a front view of a connecting interface of the electronic connection apparatus in accordance with one or more embodiments.

FIG. 7 is an exploded view of certain components of the connecting interface in accordance with one or more embodiments.

FIG. 8 is another exploded view of the certain components of the connecting interface in accordance with one or more embodiments.

FIG. 9 is a perspective view of connectors in a stacked configuration and other componentry in accordance with one or more embodiments.

FIG. 10 is another perspective view of the connectors in the stacked configuration and the other componentry in accordance with one or more embodiments.

FIG. 11 is a front view of a first back shell and a first connector in accordance with one or more embodiments.

FIG. 12 is a side view of the first back shell and the first connector in accordance with one or more embodiments.

FIG. 13 is a bottom view of the first back shell and the first connector in accordance with one or more embodiments.

FIG. 14 is a front view of a second back shell and a second connector in accordance with one or more embodiments.

FIG. 15 is a side view of the second back shell and the second connector in accordance with one or more embodiments.

FIG. 16 is a top view of the second back shell and the second connector in accordance with one or more embodiments.

FIG. 17 is a flowchart of a procedure to utilize a back shell assembly on multiple connectors in accordance with one or more embodiments.

### DETAILED DESCRIPTION

As described above, it may be useful to attach an individual back shell device around a connector for protection. However, suppose that a situation exists in which a signal connector and a power connector are in relatively close proximity to each other when connecting with the same equipment. Along these lines, space may be limited such that it would be extremely difficult (e.g., without distorting or damaging componentry) or even impossible to simultaneously attach one individual back shell device around the signal connector and another individual back shell device around the power connector while the signal connector and the power connector connect with the equipment at the same time.

That is, if an individual back shell device is attached around the signal connector, it may not be possible to attach another individual back shell device around the power connector while the connectors connect with the equipment. Alternatively, if an individual back shell device is attached around the power connector, it may not be possible to attach another individual back shell device around the signal connector while the connectors connect with the equipment. Moreover, in a very tight situation, it may not be possible to attach an individual back shell device to either the signal connector or the power connector while both connectors connect with the equipment at the same time.

To address this situation, the manufacturer may consider redesigning the equipment to provide more space between the signal connector and the power connector to accommodate individual back shell devices around both connectors while the connectors connect with the equipment at the same time. However, such a redesign may require extensive time, design work, testing, and/or may not be practical. What is needed, therefore, is a way to effectively provide back shell protection to multiple connectors when space is limited between the connectors while the connectors connect with equipment.

The above need is addressed at least in part by a back shell assembly having back shell sections (or simply back shells) which fit around portions of connectors. For example, a first back shell may be constructed and arranged to fit around a portion of a first connector. Similarly, a second back shell may be constructed and arranged to fit around a portion of a second connector. Hardware may then be used to fasten the first back shell and the second back shell together enabling the first back shell and the second back shell to provide electromagnetic interference (EMI) shielding around both connectors. In some arrangements, when fastened together, the first and second back shells define a stacked connector space within which the first and second connectors are able to reside (e.g., one atop the other). In some arrangements, the connectors are different (e.g., one connector is a signal connector and the other connector is a power connector). Such improvements alleviate the need for equipment redesigns and provide ways to effectively provide back shell protection to multiple connectors when space is limited between the connectors.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

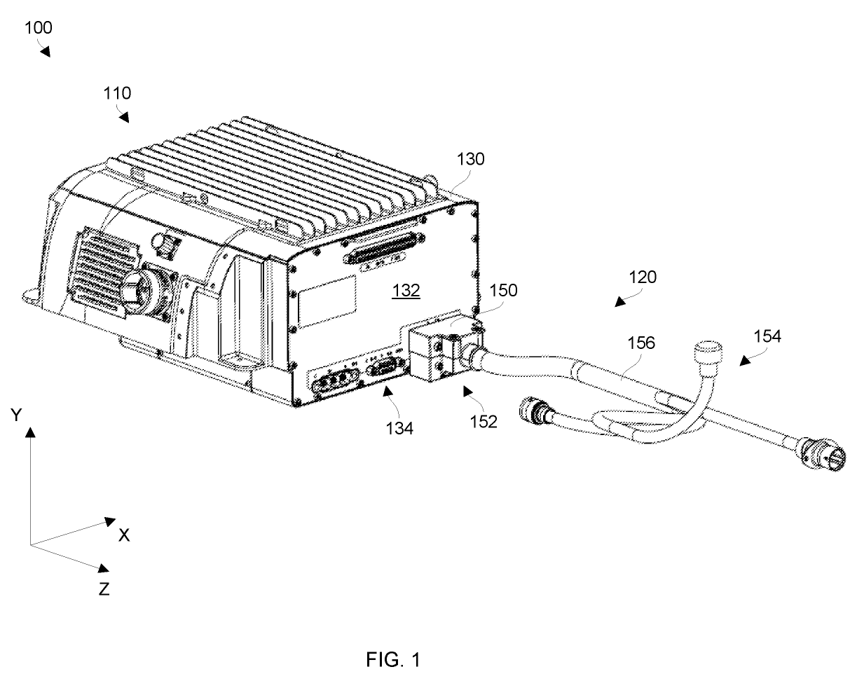

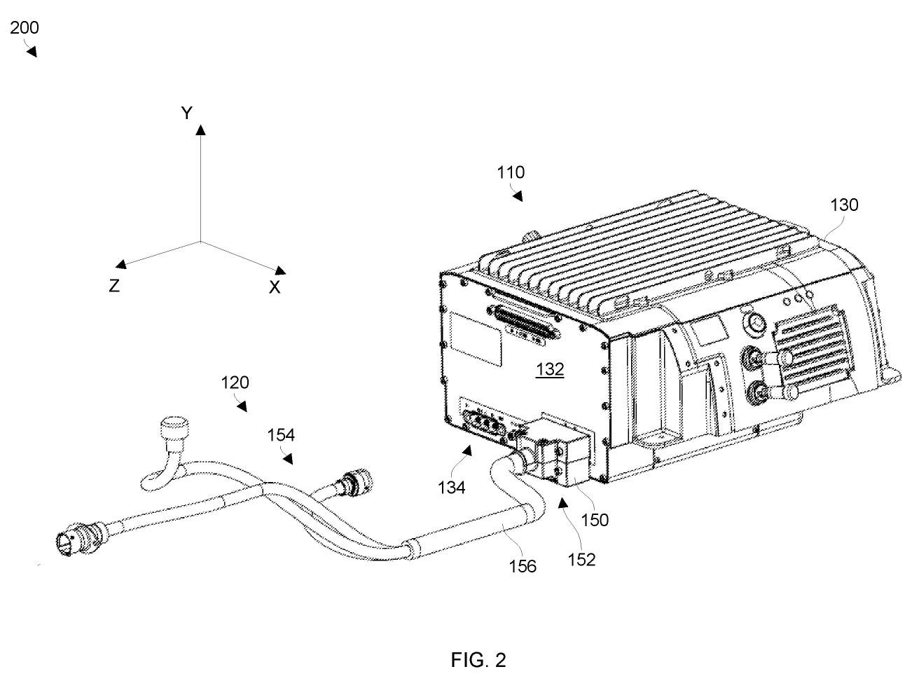

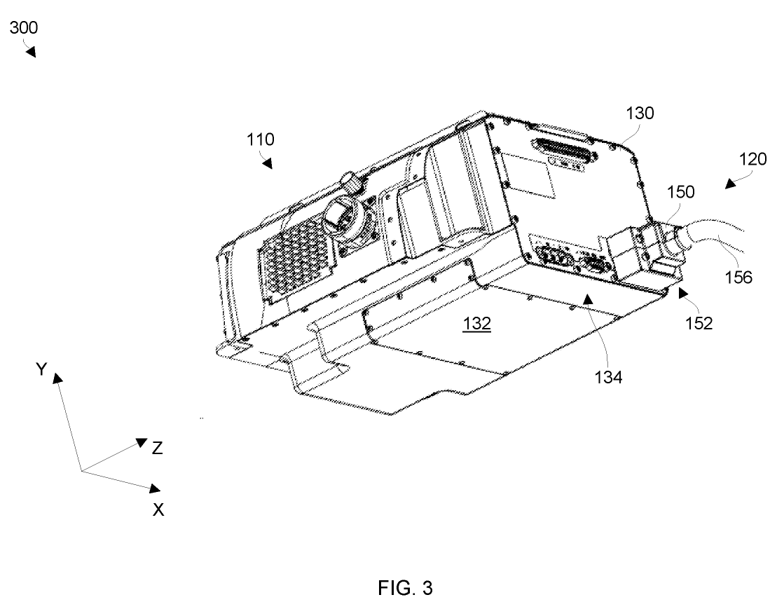

FIGS. 1 through 3 show views of at least a portion of an electronic environment which utilizes a back shell assembly in accordance with certain embodiments. FIG. 1s a perspective view 100 of the electronic environment from a first angle. FIG. 2 is a perspective view 200 of the electronic environment from a second angle. FIG. 3 is a perspective view 300 of the electronic environment from a third angle. As shown by the various view of FIGS. 1 through 3, the electronic environment includes electronic equipment 110 and an electronic connection apparatus 120 which couples with the electronic equipment 110.

The electronic equipment 110 is constructed and arranged to perform various electronic operations (e.g., power signal regulation, motor control, monitoring, combinations thereof, etc.). Along these lines, the electronic equipment 110 includes a housing 130, internal circuitry 132 (shown generally by reference number 132), connectors 134, and so on. The housing 130 is constructed and arranged to contain the internal circuitry 132 (e.g., to guard against dust/debris, tampering, etc.). The internal circuitry 132 is constructed and arranged to reside within the housing 130 and perform the various electronic operations. The connectors 134 are constructed and arranged to interface with other connectors to enable the internal circuitry 132 to input and output signals.

The electronic connection apparatus 120 is constructed and arranged to convey electronic signals from and/or to the electronic equipment 110 (e.g., power signals, sensor signals, control signals, combinations thereof, etc.). Along these lines, the electronic connection apparatus 120 includes a back shell assembly 150, a set of connectors 152 (shown generally by arrow 152), a set of cables 154, a sleeve 156, and so on. The back shell assembly 150 is constructed and arranged to provide protection (e.g., EMI shielding, strain relief, etc.). The set of connectors 152 is constructed and arranged to interface with corresponding connectors 134 of the electronic equipment 110. The set of cables 154 terminates at the set of connectors 152 enabling signal exchange with the electronic equipment 110 through the set of connectors 152. The sleeve 156 provides protection in a manner similar to that of the back shell assembly 150 (e.g., EMI shielding, strain relief, etc.).

During operation, the electronic equipment 110 and the electronic connection apparatus 120 are able to accomplish useful work. For example, such componentry may operate one or more motors of a vehicle such as an aircraft, a watercraft, a land vehicle, and so on. Other applications, environments, and situations are suitable as well.

It should be understood that various safeguards are provided to prevent the operation of the electronic equipment 110 and the electronic connection apparatus 120 from interfering with other external components, and vice versa. Along these lines, the housing 130 of the electronic equipment 110 as well as the back shell assembly 150 and the sleeve 156 of the electronic connection apparatus 120 provide EMI shielding. In particular, the housing 130, the back shell assembly 150, and the sleeve 156 include metallic/conductive material which reduces and/or redirects electromagnetic fields (EMF) to prevent signals within the electronic environment from disrupting operation (e.g., EMI from escaping and/or EMI from entering).

In some arrangements, at least some of the metallic/conductive material of the housing 130, the back shell assembly 150, and/or the sleeve 156 connects with ground (e.g., aerial vehicle ground of an aerial vehicle). Such metallic/conductive material therefore provides both EMI shielding and grounding for protection.

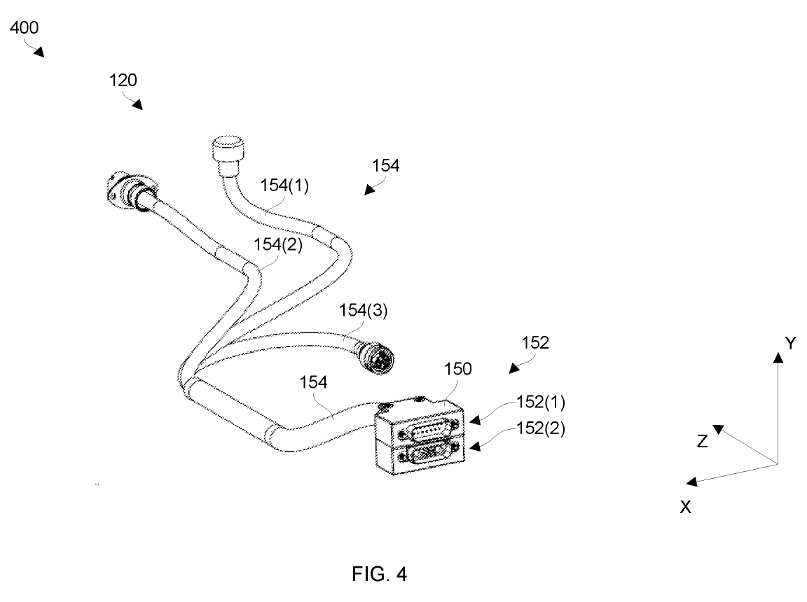

It should be understood that the electronic connection apparatus 120 and the electronic equipment 110 connect together through complementary connectors. To decouple (or disengage) the electronic connection apparatus 120 from the electronic equipment 110, the connecting end of the electronic connection apparatus 120 is moved in the positive Z-direction away from the electronic equipment 110. Similarly, to couple (or engage) the electronic connection apparatus 120 with the electronic equipment 110, the connecting end of the electronic connection apparatus 120 is moved in the negative Z-direction toward the electronic equipment 110. Further details will now be provided with reference to FIGS. 4 through 6.

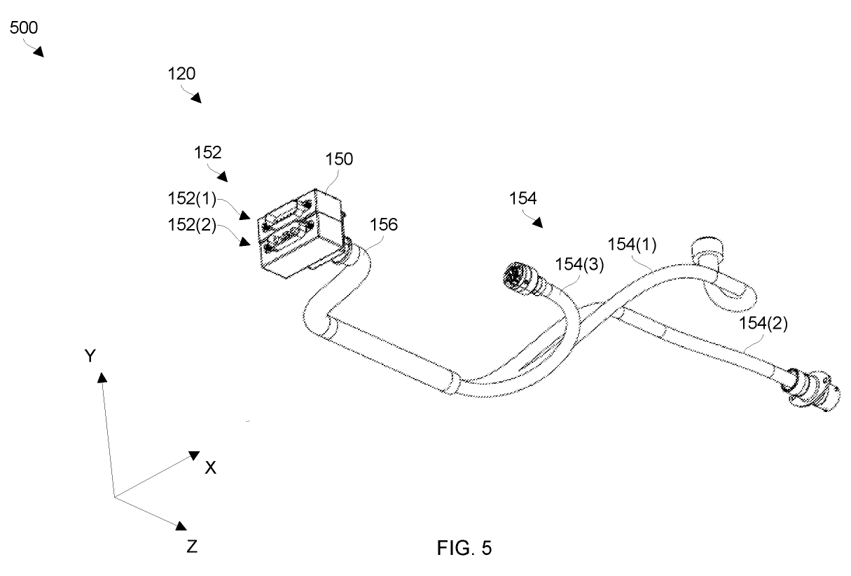

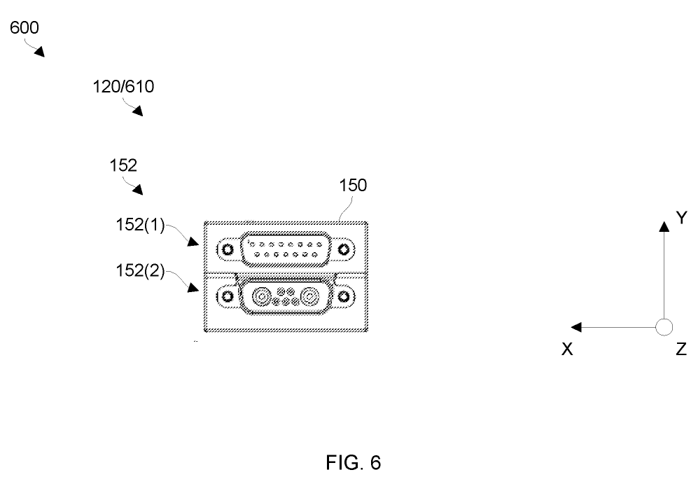

FIGS. 4 through 6 show certain details of the electronic connection apparatus 120 in accordance with certain embodiments. FIG. 4 is a perspective view 400 from a first angle. FIG. 5 is a perspective view 500 from a second angle. FIG. 6 is a front view 600 of a connecting interface of the electronic connection apparatus 120.

As shown in FIGS. 4 through 6, the electronic connection apparatus 120 includes multiple connectors 152(1), 152(2), and multiple cables 154(1), 154(2), 154(3). It should be understood that the number of connectors 152 and the number of cables 154 are different by way of example only (e.g., one connector 152 terminates multiple cables 154). In other embodiments, there are the same number of connectors 152 and cables 154 (e.g., each connector 152 terminates a respective cable 154).

As best seen in FIG. 6, the connectors 152 are spaced closely together to form a connecting interface 610 for connecting to other equipment (e.g., see FIGS. 1 through 3). However, there is very little space if any between the connectors 152(1), 152(2). Such a situation may prevent an individual back shell device from attaching around either connector 152(1) or 152(2).

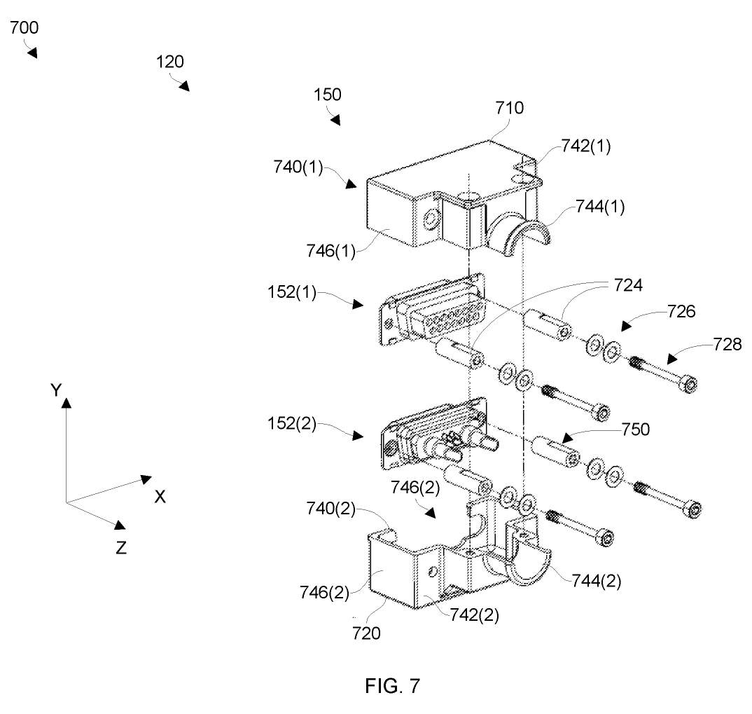

However, in accordance with certain improvements disclosed herein, the back shell assembly 150 extends around both connectors 152(1), 152(2). Accordingly, the connectors 152(1), 152(2) are able to enjoy back shell protection although there is little to no space to enable an individual back shell device from properly installing around just one connector 152. Further details will now be provided with reference to FIGS. 7 through 10.

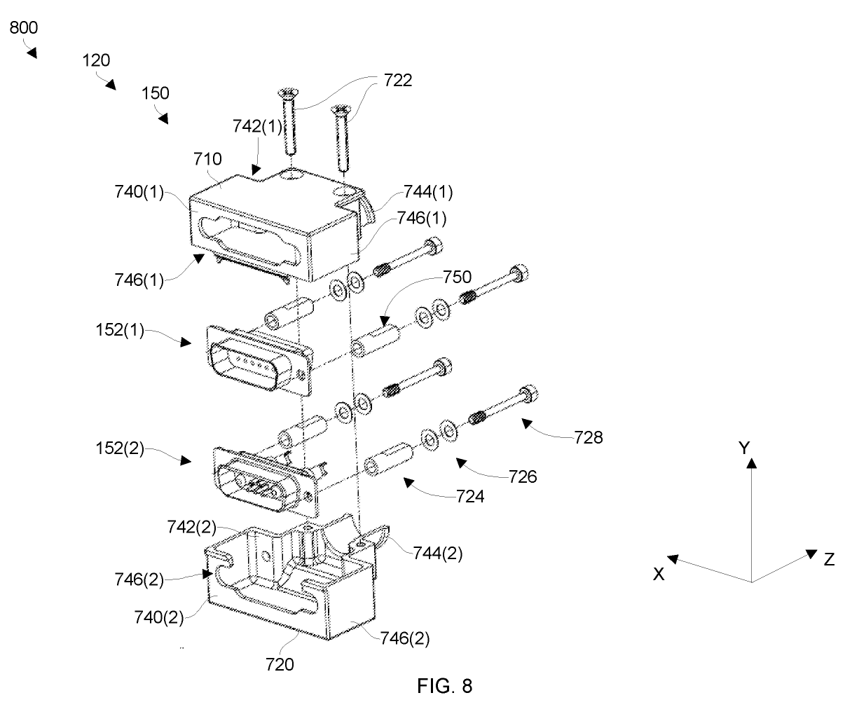

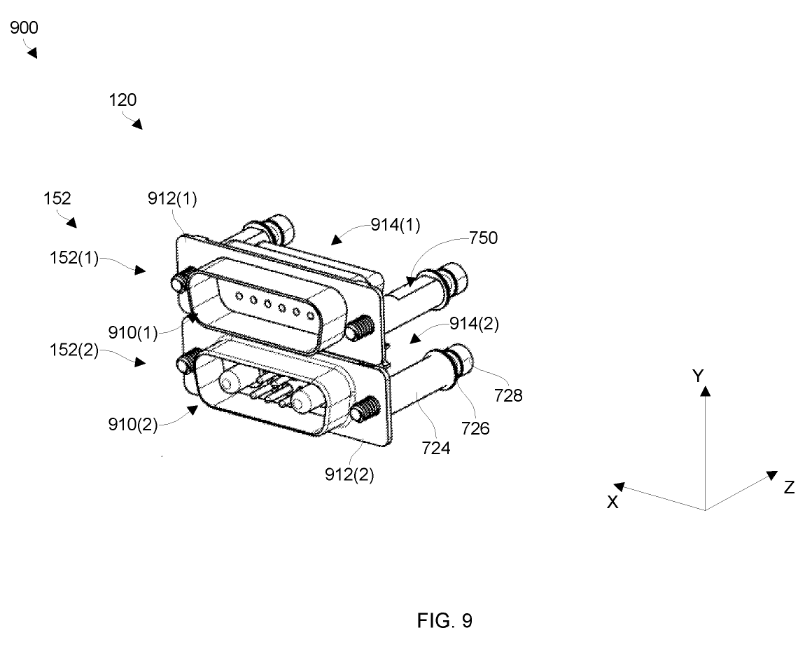

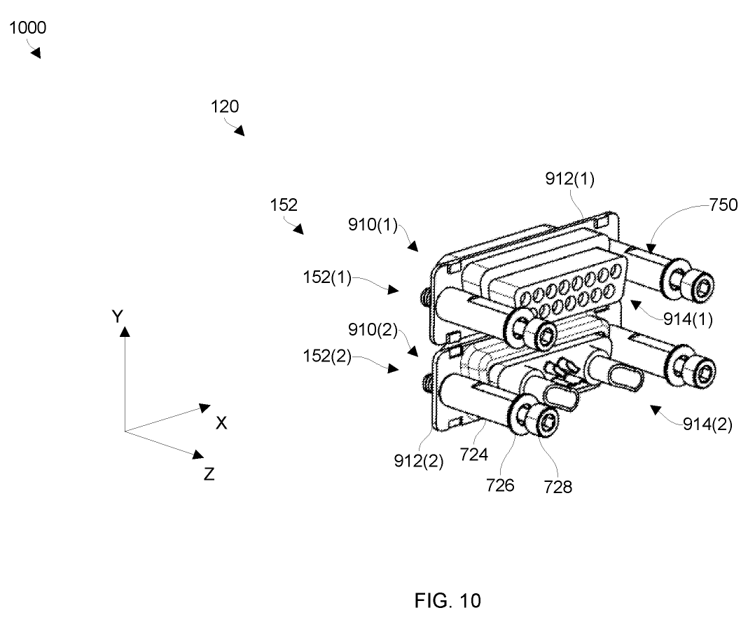

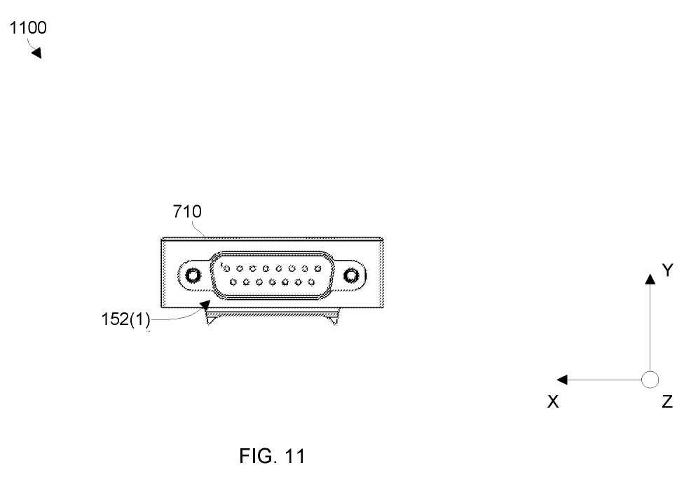

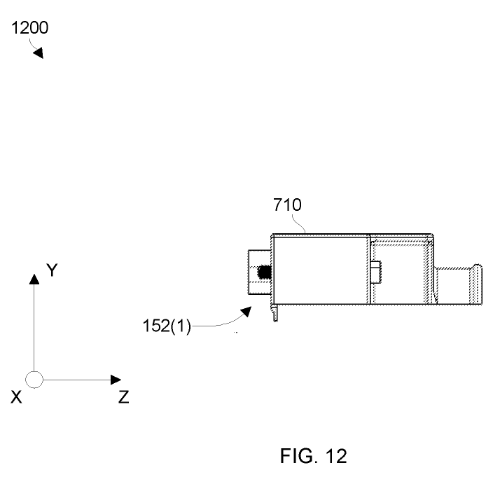

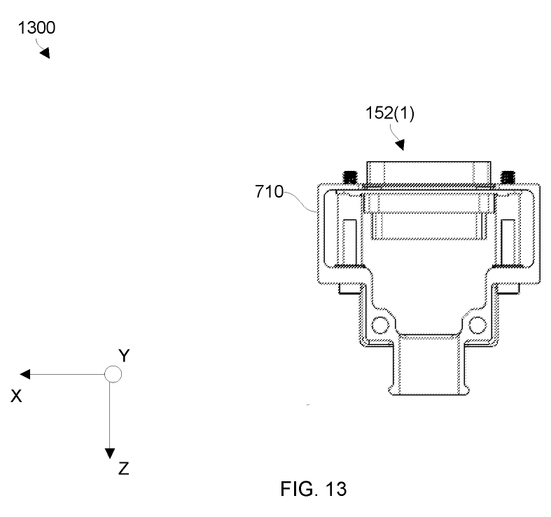

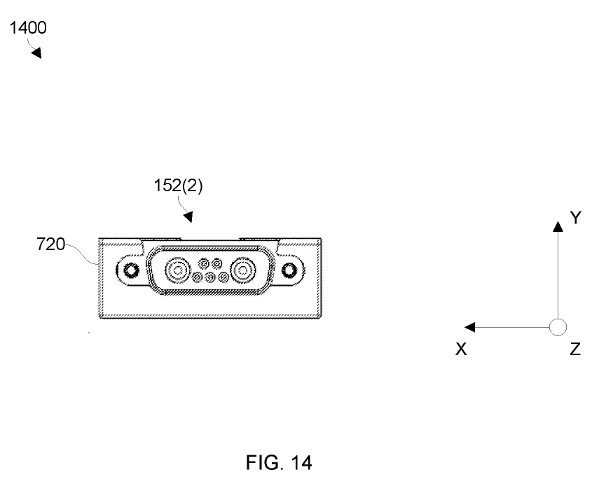

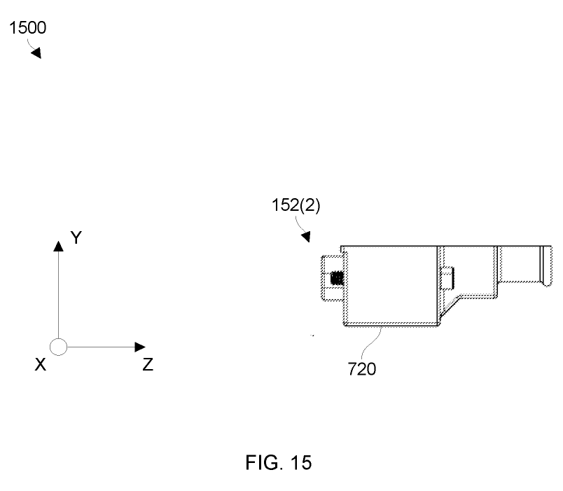

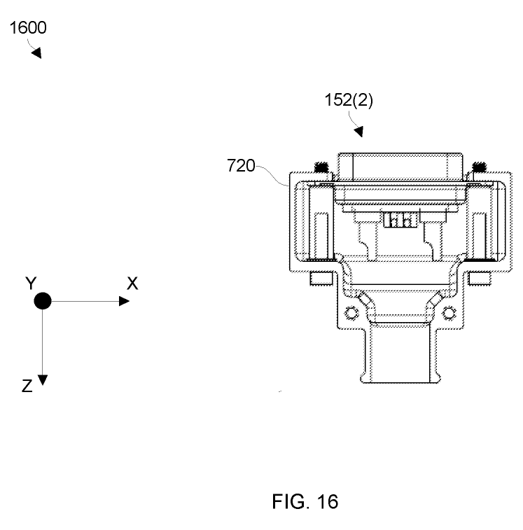

FIGS. 7 through 16 show certain details of the electronic connection apparatus 120 in accordance with certain embodiments. FIG. 7 is an exploded view 700 of a portion of the electronic connection apparatus 120. FIG. 8 is another view 800 of the portion of the electronic connection apparatus 120. FIG. 9 is a perspective view 900 of the connectors 152(1), 152(2) while arranged in a stacked configuration (e.g., to fit within the back shell assembly 150). FIG. 10 is another perspective view 1000 of the connectors 152(1), 152(2) while arranged in the stacked configuration. FIG. 11 is a front view 1100 of the upper back shell 710 while fitting around the connector 152(1). FIG. 12 is a side view 1200 of the upper back shell 710 while fitting around the connector 152(1). FIG. 13 is a bottom view 1300 of the upper back shell 710 while fitting around the connector 152(1). FIG. 14 is a front view 1400 of the lower back shell 720 while fitting around the connector 152(2). FIG. 15 is a side view 1500 of the lower back shell 720 while fitting around the connector 152(2). FIG. 16 is a top view 1600 of the lower back shell 720 while fitting around the connector 152(2).

As best seen in FIGS. 7 and 8, the back shell assembly 150 includes an upper back shell 710, a lower back shell 720, fastening hardware 722, standoffs 724, washers 726, and threaded members 728. In accordance with certain embodiments, the back shells 710, 720 include conductive material to provide robust and reliable EMI shielding while the connectors 152 reside in a tight stacked configuration.

Certain features of the connectors 152 are best seen in FIGS. 9 and 10. For example, the connector 152(1) includes a connecting interface 910(1), a flange 912(1), and a set of connecting terminals (e.g., pins, sockets, contacts, posts, combinations thereof, etc.) 914(1). Similarly, the connector 152(2) includes a connecting interface 910(2), a flange 912(2), and a set of connecting terminals 914(2).

In some embodiments, the connectors 152(1), 152(2) are different types of connectors. For example, the connectors 152(1), 152(2) may have different form factors, different pin/terminal/contact layouts, different interface geometries, combinations thereof, etc.

By way of example, the connector 152(1) is shown as being a signal connector. That is, the connecting interface 910(1) and the set of connecting terminals 914(1) are constructed and arranged to carry electronic signals such as control signals, status signals, sensor signals, communications signals, combinations thereof, and so on (e.g., see FIGS. 7-9 and 11).

On the other hand, the connector 152(2) is shown as being a power connector. That is, the connecting interface 910(2) and the set of connecting terminals 914(2) are constructed and arranged to carry electric power (e.g., see FIGS. 7-9 and 14). Along these lines, in order to carry power signals, the set of terminals 914(2) may be thicker (e.g., be of a higher gauge) than the set of terminals 914(1).

It should be understood that other configurations are suitable as well such as the connectors 152(1), 152(2) being of the same type. Alternatively or additionally, there may be more than just two connectors (e.g., three, four, etc.) and such connectors may be all of the same types, all of different types, some of one type, some of another type, and so on.

The upper back shell 710 of the back shell assembly 150 is constructed and arranged to fit around a portion of the connector 152(1) (e.g., see FIGS. 7 and 8). Along these lines, the upper back shell 710 covers an upper portion of the connector 152(1). In particular, the upper back shell 710 includes a front wall 740(1), a rear wall 742(1), a rear collar 744(1), and a mid-section 746(1) which extends between the front wall 740(1) and the rear wall 742(1) to extend around three sides of the connector 152(1) (e.g., two lateral sides and a top).

Similarly, the lower back shell 720 of the back shell assembly 150 is constructed and arranged to fit around a portion of the connector 152(2) (e.g., see FIGS. 7 and 8). Along these lines, the lower back shell 720 covers a lower portion of the connector 152(2). In particular, the lower back shell 720 includes a front wall 740(2), a rear wall 742(2), a rear collar 744(2), and a mid-section 746(2) which extends between the front wall 740(2) and the rear wall 742(2) to extend around three sides of the connector 152(2) (e.g., two lateral sides and a bottom).

The front wall 740(1) of the upper back shell 710 defines an opening 746(1) (e.g., see FIG. 8) which allows the connecting interface 910(1) of the connector 152(1) to insert therethrough during installation of the connector 152(1) within the upper back shell 710. Likewise, the front wall 740(2) of the lower back shell 720 defines an opening 746(2) which allows the connecting interface 910(2) of the connector 152(2) to insert therethrough during installation of the connector 152(2) within the lower back shell 720.

It should be understood that the shapes of the edges of the upper back shell 710 and the lower back shell 720 complement each other thus enabling the upper back shell 710 and the lower back shell 720 to form a tight, reliable seal when brought together along the Y-axis. Moreover, while the upper back shell 710 and the lower back shell 720 are together, the upper back shell 710 and the lower back shell 720 define an internal connector space within which the connectors 152(1), 152(2) are able to reside when in the stacked configuration (e.g., see FIGS. 9 and 10). Accordingly, the back shell assembly 150 can shield connectors 152 that are located too close to each other to prevent using individual back shells.

Additionally, while the upper back shell 710 and the lower back shell 720 are together, the upper back shell 710 and the lower back shell 720 orient the respective connecting interfaces 910(1), 910(2) of the connectors 152(1), 152(2) to face in the negative Z-direction. Accordingly, the connecting interfaces 910(1), 910(2) are properly positioned to face corresponding connectors of equipment for easy mating (e.g., also see FIGS. 1 through 3).

Furthermore, while the upper back shell 710 and the lower back shell 720 are together, the rear collars 744(1), 744(2) of the back shells 710, 720 form an elongated collared passageway through which the cables 154 are able to pass. This elongated collared passageway provides strain relief and holds the cables 154 in an optimized orientation to prevent damage (e.g., kinking, twisting, etc.). Also, the elongated collared passageway provides a surface to fasten the sleeve 156 (e.g., see FIGS. 1 through 3).

The fastening hardware 722 (FIG. 8) is constructed and arranged to fasten (or hold) the connectors 152(1), 152(2) together. Along these lines, the fastening hardware 722 may include a set of screws (or bolts) which extend through the connectors 152(1), 152(2) along the Y-axis. In some arrangements, the upper back shell 710 provides countersinks (or counterbores) to recess the heads of the fastening hardware 722 to maintain a low profile along the Y-axis.

The standoffs 724 are constructed and arranged to properly position the connectors 152(1), 152(2) within respective back shells 710, 720. Along these lines, respective standoffs 724 are moved into their proper installation position while the upper back shell 710 and the lower back shell 720 remain separated. Once the standoffs 724 are properly positioned within the upper back shell 710 and the lower back shell 720, the standoffs 724 extend from inner surfaces of the rear walls 742(1), 742(2) of the back shells 710, 720 to urge the flanges 912(1), 912(2) of the connectors 152(1), 152(2) forward (in the negative Z-direction) against the inner surfaces of the front walls 740(1), 740(2) of the back shells 710, 720.

The washers 726 are constructed and arranged to remove any slack between the standoffs 724 and the back shells 710, 720 when the connectors 152(1), 152(2) are in place within the back shells 710, 720. Along these lines, the washers 726 sit between the standoffs and the flanges 912(1), 912(2) to keep the flanges 912(1), 912(2) flush against the front walls 740(1), 740(2) of the connectors 152(1), 152(2). The washers 726 initially install within the back shells 710, 720 in a manner similar to that for the standoffs 724 while the upper back shell 710 and the lower back shell 720 are separated. In some arrangements, no washers or different numbers of washers may be used than those shown in order to accommodate differences in manufacturing tolerances.

The threaded members 728 are constructed and arranged to insert through the back shells 710, 720, the standoffs 724 and the washers 726 in the negative Z-direction. Threaded ends of the threaded members 728 are then able to thread into connectors of the equipment 110 (also see FIGS. 1 through 3) to connect the back shell assembly 150 with the equipment 110.

To install the connector 152(1) within the upper back shell 710, the connecting interface 910(1) of the connector 152(1) inserts through the opening 746(1) while the flange 912(1) of the connector 152(1) is moved into the mid-section 746(1) of the connector 152(1). Additionally, one or more cables terminated by the connector 152(1) are guided into the rear collar 744(1).

Next, the standoffs 724 and washers 726 are positioned within the mid-section 746(1) to urge the flange 912(1) of the connector 152(1) against the front wall 740(1) of the upper back shell 710. Along these lines, the upper back shell 710, the standoffs 724, and the washers 726 define bores/apertures through which the threaded members 728 are able to pass. Accordingly, when the standoffs 724 and washers 726 are positioned properly, there are channels for the threaded members 728 to insert through.

Once the threaded members 728 are inserted through the channels, the threaded members 728 hold the various componentry in place. At this point, the ends of the threaded members 728 extend out of the upper back shell 710 to enable the threaded members 728 to thread into equipment (e.g., a complementary connecting interface of the equipment 110, also see FIGS. 1 through 3).

Similarly, to install the connector 152(2) within the lower back shell 720, the connecting interface 910(2) of the connector 152(2) inserts through the opening 746(2) while the flange 912(2) of the connector 152(2) is moved into the mid-section 746(2) of the connector 152(2). Additionally, one or more cables terminated by the connector 152(2) are guided into the rear collar 744(2).

Next, the standoffs 724 and washers 726 are positioned within the mid-section 746(2) to urge the flange 912(2) of the connector 152(2) against the inner surface of the front wall 740(2) of the lower back shell 720. When the standoffs 724 and washers 726 are positioned properly, there are channels for the threaded members 728 to insert through.

Subsequently, the threaded members 728 are inserted through the channels to hold the various componentry in place. At this point, the ends of the threaded members 728 extend out of the lower back shell 720 to enable the threaded members 728 to thread into equipment (e.g., a complementary connecting interface of the equipment 110, also see FIGS. 1 through 3).

In some arrangements, the standoffs 724 define internal threads through at least a portion of the bores to enable the standoffs 724 to retain the threaded members 728 once the threaded members 728 are properly installed within the back shells 710, the standoffs 724, and the washers 726. In some arrangements, the standoffs 724 further define slots or other structures 750 (e.g., wrench flats) to enable a tool (e.g., an inserted flat tab or blade) to prevent rotation of the standoffs 724 while the threaded members 728 thread within the standoffs 724.

With the connectors 152(1), 152(2) now installed within respective back shells 710, 720, the back shells 710, 720 are fastened together using the fastening hardware 722. Then, the sleeve 156 is married to the elongated collared passageway formed by the rear collars 744(1), 744(2) of the back shells 710, 720. At this point, the electronic connection apparatus 120 may be connected with the electronic equipment 110 (also see FIGS. 1 through 3).

That is, while the connectors 152(1), 152(2) are installed within their respective back shells 710, 720, the connecting interfaces 910(1), 910(2) protrude through the openings in the front walls 740(1), 740(2). Additionally, the standoffs 724 and washers 726 urge the flanges 912(1), 912(2) of the connectors 152(1), 152(2) against the inside faces of the front walls 740(1), 740(2). Accordingly, a user is able to easily connect (e.g., plug) the electronic connection apparatus 120 with other equipment.

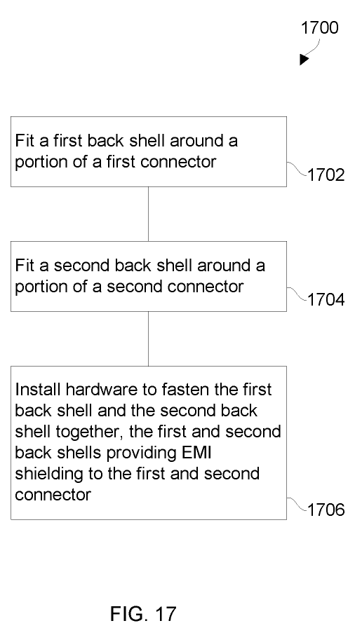

It should be understood that certain orientation details for the back shell assembly 150 are provided by way of example and/or for illustration purposes only. For example, nothing precludes the back shell assembly 150 from including back shell sections which stack the connectors 152 in a side-by-side sideways manner, or which position a power connector above a signal connector, and so on. In some arrangements, there is simply a first back shell and a second back shell and the back shell assembly 150 formed therefrom can be oriented in any manner. Moreover, in some arrangements, there are a different number of back shell sections forming the back shell assembly 150 and/or a different number of connectors 152 held by the back shell assembly 150 (e.g., three, four, etc.). Further details will now be provided with reference to FIG. 17.

FIG. 17 is a flowchart of a procedure 1700 for assembling an electronic connection apparatus in accordance with some embodiments. The procedure 1700 may be performed by an assembler (e.g., robotics and/or other types equipment, a user, combinations thereof, etc.).

At 1702, the assembler fits a first back shell around a portion of a first connector. FIGS. 11 through 13 show a first back shell which has been fit around a portion of a first connector.

At 1704, the assembler fits a second back shell around a portion of a second connector. FIGS. 14 through 16 show a second back shell which has been fit around a portion of a second connector.

At 1706, the assembler installs hardware to fasten the first back shell and the second back shell together. At this point, the first back shell and the second back shell provide EMI shielding to the first connector and the second connector. FIGS. 4 through 6 show the first back shell and the second back shell fastened together.

As described above, a back shell assembly 150 has back shells 710, 720 which fit around portions of connectors 152(1), 152(2). Along these lines, a first back shell 710 is constructed and arranged to fit around a portion of a first connector 152(1). Likewise, a second back shell 720 is constructed and arranged to fit around a portion of a second connector 152(2). Fastening hardware 722 then fastens the back shells 710, 720 together enabling back shells 710, 720 to provide EMI shielding around both connectors 152(1), 152(2).

In some arrangements, when fastened together, the back shells 710, 720 define a stacked connector space within which the connectors 152(1), 152(2) are able to reside (e.g., one atop the other, side-by-side, combinations thereof, etc.). Such improvements alleviate the need for equipment redesigns and provide ways to effectively provide back shell protection to multiple connectors when space is limited between the connectors.

While various embodiments of the present disclosure have been particularly shown and described, it will be understood by those skilled in the art that various changes in form and details may be made therein without departing from the spirit and scope of the present disclosure. Such modifications and enhancements are intended to belong to various embodiments of the disclosure.

It should be appreciated that, when there is not enough space for individual back shell devices, the way the problem has been handled before has been to move the opposite connectors on the equipment farther apart so that the individual back shell devices can be used. However, this is sometimes not possible due to geometric limitations or circuit board sizing.

Along these lines, in the past, the minimum spacing of connectors may have been determined by how closely their respective individual back shell housings can be placed. In some applications, it is necessary to space connectors more closely than individual housings may allow for, due to geometric limitations or circuit board sizing for example. Certain techniques disclosed herein avoid such limitations.

In accordance with certain embodiments, a back shell assembly is used to EMI shield connectors (of similar or varying types) that are located in too close proximity to one another to use two separate standard back shells. The novelty of this assembly is that it is able to shield connectors that are located too close to each other to use individual back shells. Furthermore, this assembly can accommodate different styles of connectors such that it is not limited to one connector type at a time. This assembly is low profile, light weight, and is able to fully retain the mating hardware of the connectors. It enables the user to make the full electrical connection before installing the mounting hardware, thus making the install much easier. Accordingly, a connector assembly with an EMI shielding back shell that houses multiple connectors is provided.

In some embodiments, the assembly includes: an upper back shell, a lower back shell, retaining standoffs and mounting hardware. The upper back shell is used to house one connector and the lower back shell is used to house the other connector (they can be different styles of connectors). These connectors are placed in the inner wall of the back shell and protrude through the front face. Once the connectors are placed into their respective back shell, the retaining standoff is placed between the inner face of the connector and the inner back wall of the back shell.

This standoff has three functions as follows. First, it provides forward force on the back of the connector such that it cannot fall out of the back shell (this can be aided by shim if the tolerance stack requires). Second, it has a threaded portion to retain the connector’s mounting hardware. Third, it has a counterbore on the connector side of the connection that the threads of the mounting hardware can live in during installation. Once each portion of the back shells are populated with the connectors and retaining standoffs they are bolted together to form a completed assembly. It is worth noting that the back shells have a feature on the area where the cables exit that is contoured such that cable shielding can be attached to and retained (via a zip tie or stepless ear clamp).

It should be appreciated that such a connector assembly may thus include first and second connectors, and a shielding back shell housing having an upper back shell connected to a lower back shell, the back shells being made of a conductive material and having respective front walls surrounding respective openings through which forward parts of the respective first and second connectors extend. Each connector has a flange being urged into abutment with the front wall of the respective back shell by respective standoffs extending from a back wall of the respective back shell.

It should be understood that such a connector assembly may be well suited for use on unmanned aerial vehicles (UAVs). For example, there may be a power module that has connectors that are in too close proximity to each other to use individual back shells.

Moreover, the connector assembly could be used on a vast array of applications where EMI shielding is needed with notable space limitations. For example, the connector assembly can be used on military equipment containing electronics and any electronic packaging with notable space constraints. It could be used in any industry that needs electronic assemblies with EMI shielding with tight space constraints.

In some embodiments, the assembly includes the four following parts: an upper back shell of a conductive material, a lower back shell also of a conductive material, retaining standoffs, and mounting hardware. The upper back shell is used to house one connector, and the lower back shell is used to house the other connector (these can be different styles of connectors). Each connector is placed against the inner surface of a front wall of the respective back shell and has a central portion protruding through an opening. Once the connectors are placed into their respective back shells, the retaining standoffs are placed between the inner face of the connector and the inner back wall of the back shell.

Some embodiments are directed to a connector assembly which includes first and second connectors. The connector assembly further includes a shielding back shell housing having an upper back shell connected to a lower back shell, the back shells being made of a conductive material and having respective front walls surrounding respective openings through which forward parts of the respective first and second connectors extend, each connector having a flange being urged into abutment with the front wall of the respective back shell by respective standoffs extending from a back wall of the respective back shell.

The description herein provides examples for the purposes of understanding and is not intended to limit the invention or the application and uses of the same. Furthermore, there is no intention to be bound by any expressed or implied theory presented herein.

Directional references such as “top,” “bottom,” “left,” “right,” “above,” “below,” "upper," "lower," and so forth, unless otherwise stated, are not intended to require any preferred orientation and are made with reference to the orientation of the corresponding figure or figures for purposes of illustration.

It will be appreciated that the steps of various processes described herein are non-limiting examples of suitable processes according to embodiments and are for the purposes of illustration. Systems and devices according to embodiments herein may use any suitable processes including those that omit steps described above, perform those steps and similar steps in different orders, and the like. It will also be appreciated that well-known features may be omitted for clarity.

Certain embodiments are directed to a method of assembling an electronic connection apparatus. The method includes fitting a first back shell around a portion of a first connector. The method further includes fitting a second back shell around a portion of a second connector. The method further includes installing hardware to fasten the first back shell and the second back shell together. The first back shell and the second back shell provide EMI shielding to the first connector and the second connector when the first back shell is fit around the portion of the first connector, the second back shell is fit around the portion of the second connector, and the hardware fastens the first back shell and the second back shell together.

Other embodiments are directed to a back shell assembly which includes a first back shell constructed and arranged to fit around a portion of a first connector. The back shell assembly further includes a second back shell constructed and arranged to fit around a portion of a second connector. The back shell assembly further includes hardware constructed and arranged to fasten the first back shell and the second back shell together, the first back shell and the second back shell providing EMI shielding to the first connector and the second connector when the first back shell is fit around the portion of the first connector, the second back shell is fit around the portion of the second connector, and the hardware fastens the first back shell and the second back shell together.

Yet other embodiments are directed to an electronic connection apparatus which includes a first connector constructed and arranged to connect with electronic equipment, and a second connector constructed and arranged to connect with the electronic equipment. The electronic connection apparatus further includes a back shell assembly which has:

(A) a first back shell constructed and arranged to fit around a portion of the first connector,

(B) a second back shell constructed and arranged to fit around a portion of the second connector, and

(C) hardware constructed and arranged to fasten the first back shell and the second back shell together, the first back shell and the second back shell providing EMI shielding to the first connector and the second connector when the first back shell is fit around the portion of the first connector, the second back shell is fit around the portion of the second connector, and the hardware fastens the first back shell and the second back shell together.

In accordance with one or more embodiments, the first back shell of the back shell assembly includes a first front wall that defines a first front opening through which a connecting interface of the first connector is permitted to extend when the first back shell fits around the portion of the first connector. Additionally, the second back shell of the back shell assembly includes a second front wall that defines a second front opening through which a connecting interface of the second connector is permitted to extend when the second back shell fits around the portion of the second connector.

In accordance with one or more embodiments, the first back shell further includes a first rear section. Additionally, the second back shell further includes a second rear section. Furthermore, the first rear section and the second rear section form a cable passageway through which a first cable attached to the first connector and a second cable attached to the second connector are permitted to pass when the first back shell fits around the portion of the first connector, the second back shell fits around the portion of the second connector, and the hardware fastens the first back shell and the second back shell together.

In accordance with one or more embodiments, the first rear section of the first back shell further defines first alignment holes. Additionally, the second rear section of the second back shell further defines second alignment holes. Furthermore, the hardware, when fastening the first back shell and the second back shell together, is constructed and arranged to insert through the first and second alignment holes to align the first back shell with the second back shell.

In accordance with one or more embodiments, the first back shell includes a first front wall and a first rear section. Additionally, the second back shell includes a second front wall and a second rear section. Furthermore, the back shell assembly further includes:

(i) first standoffs constructed and arranged to urge a flange of the first connector into abutment with the first front wall of the first back shell when the first back shell fits around the portion of the first connector and the first standoffs are inserted between the first front wall and the first rear section of the first back shell; and

(ii) second standoffs constructed and arranged to urge a flange of the second connector into abutment with the second front wall of the second back shell when the second back shell fits around the portion of the second connector and the second standoffs are inserted between the second front wall and the second rear section of the second back shell.

In accordance with one or more embodiments, the first standoffs define first bores. Additionally, the second standoffs define second bores. Furthermore, the back shell assembly further includes:

(i) first threaded members constructed and arranged to extend through the first bores defined by the first standoffs to fasten the first back shell to equipment; and

(ii) second threaded members constructed and arranged to extend through the second bores defined by the second standoffs to fasten the second back shell to the equipment.

In accordance with one or more embodiments, the first standoffs further define internal threads to engage with the first threaded members. Additionally, the second standoffs further define internal threads to engage with the second threaded members.

In accordance with one or more embodiments, the first back shell and the second back shell are constructed and arranged to define a stacked connector space when the hardware fastens the first back shell and the second back shell together. Additionally, the first connector and the second connector are positioned one atop the other together in a stacked connector configuration when the first and second connectors populate the stacked connector space.

In accordance with one or more embodiments, when the first and second connectors populate the stacked connector space, the first back shell shields a top and two sides of the first connector and the second back shell shields a bottom and two sides of the second connector leaving a bottom of the first connector and a top of the second connector unshielded relative to each other. Such embodiments are particularly well suited for connecting with equipment which does not leave enough space for the connectors to have their own complete back shell devices, respectively. However, other orientations are suitable as well.

In accordance with one or more embodiments, one of the first connector and the second connector is a signal connector constructed and arranged to carry electronic signals. Additionally, the other of the first connector and the second connector is a power connector constructed and arranged to carry power signals and being different from the signal connector.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Also, the foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematics and component features shown in the figures depict one exemplary arrangement of elements, additional intervening elements, devices, features, or components may be present in one or more other embodiments of the depicted subject matter.

Those skilled in the art will therefore understand that various changes in form and detail may be made to the embodiments disclosed herein without departing from the scope of the following claims.

What is claimed is:

1. Electronic connection apparatus, comprising:
a first connector constructed and arranged to connect with electronic equipment;
a second connector constructed and arranged to connect with the electronic equipment; and
a back shell assembly which includes:
a first back shell constructed and arranged to fit around a portion of the first connector,
a second back shell constructed and arranged to fit around a portion of the second connector, and
hardware constructed and arranged to fasten the first back shell and the second back shell together, the first back shell and the second back shell providing electromagnetic interference (EMI) shielding to the first connector and the second connector when the first back shell is fit around the portion of the first connector, the second back shell is fit around the portion of the second connector, and the hardware fastens the first back shell and the second back shell together.

2. The electronic connection apparatus of claim 1, wherein the first back shell of the back shell assembly includes a first front wall that defines a first front opening through which a connecting interface of the first connector is permitted to extend when the first back shell fits around the portion of the first connector; and
wherein the second back shell of the back shell assembly includes a second front wall that defines a second front opening through which a connecting interface of the second connector is permitted to extend when the second back shell fits around the portion of the second connector.

3. The electronic connection apparatus of claim 2, wherein the first back shell further includes a first rear section;
wherein the second back shell further includes a second rear section; and
wherein the first rear section and the second rear section form a cable passageway through which a first cable attached to the first connector and a second cable attached to the second connector are permitted to pass when the first back shell fits around the portion of the first connector, the second back shell fits around the portion of the second connector, and the hardware fastens the first back shell and the second back shell together.

4. The electronic connection apparatus of claim 3, wherein the first rear section of the first back shell further defines first alignment holes;
wherein the second rear section of the second back shell further defines second alignment holes; and
wherein the hardware, when fastening the first back shell and the second back shell together, is constructed and arranged to insert through the first and second alignment holes to align the first back shell with the second back shell.

5. The electronic connection apparatus of claim 1, wherein the first back shell includes a first front wall and a first rear section;
wherein the second back shell includes a second front wall and a second rear section; and
wherein the back shell assembly further comprises:
first standoffs constructed and arranged to urge a flange of the first connector into abutment with the first front wall of the first back shell when the first back shell fits around the portion of the first connector and the first standoffs are inserted between the first front wall and the first rear section of the first back shell; and
second standoffs constructed and arranged to urge a flange of the second connector into abutment with the second front wall of the second back shell when the second back shell fits around the portion of the second connector and the second standoffs are inserted between the second front wall and the second rear section of the second back shell.

6. The electronic connection apparatus of claim 5, wherein the first standoffs define first bores;
wherein the second standoffs define second bores; and
wherein the back shell assembly further comprises:
first threaded members constructed and arranged to extend through the first bores defined by the first standoffs to fasten the first back shell to equipment; and
second threaded members constructed and arranged to extend through the second bores defined by the second standoffs to fasten the second back shell to the equipment.

7. The electronic connection apparatus of claim 6, wherein the first standoffs further define internal threads to engage with the first threaded members; and
wherein the second standoffs further define internal threads to engage with the second threaded members.

8. The electronic connection apparatus of claim 1, wherein the first back shell and the second back shell are constructed and arranged to define a stacked connector space when the hardware fastens the first back shell and the second back shell together; and
wherein the first connector and the second connector are positioned one atop the other together in a stacked connector configuration when the first and second connectors populate the stacked connector space.

9. The electronic connection apparatus of claim 8, wherein, when the first and second connectors populate the stacked connector space, the first back shell shields a top and two sides of the first connector and the second back shell shields a bottom and two sides of the second connector leaving a bottom of the first connector and a top of the second connector unshielded relative to each other.

10. The electronic connection apparatus of claim 9, wherein one of the first connector and the second connector is a signal connector constructed and arranged to carry electronic signals; and
wherein the other of the first connector and the second connector is a power connector constructed and arranged to carry power signals and being different from the signal connector.

11. A back shell assembly, comprising:
a first back shell constructed and arranged to fit around a portion of a first connector;
a second back shell constructed and arranged to fit around a portion of a second connector; and
hardware constructed and arranged to fasten the first back shell and the second back shell together, the first back shell and the second back shell providing electromagnetic interference (EMI) shielding to the first connector and the second connector when the first back shell is fit around the portion of the first connector, the second back shell is fit around the portion of the second connector, and the hardware fastens the first back shell and the second back shell together.

12. The back shell assembly of claim 11, wherein the first back shell includes a first front wall that defines a first front opening through which a connecting interface of the first connector is permitted to extend when the first back shell fits around the portion of the first connector; and
wherein the second back shell includes a second front wall that defines a second front opening through which a connecting interface of the second connector is permitted to extend when the second back shell fits around the portion of the second connector.

13. The back shell assembly of claim 12, wherein the first back shell further includes a first rear section;
wherein the second back shell further includes a second rear section; and
wherein the first rear section and the second rear section form a cable passageway through which a first cable attached to the first connector and a second cable attached to the second connector are permitted to pass when the first back shell fits around the portion of the first connector, the second back shell fits around the portion of the second connector, and the hardware fastens the first back shell and the second back shell together.

14. The back shell assembly of claim 13, wherein the first rear section of the first back shell further defines first alignment holes;
wherein the second rear section of the second back shell further defines second alignment holes; and
wherein the hardware, when fastening the first back shell and the second back shell together, is constructed and arranged to insert through the first and second alignment holes to align the first back shell with the second back shell.

15. The back shell assembly of claim 11, wherein the first back shell includes a first front wall and a first rear section;
wherein the second back shell includes a second front wall and a second rear section; and
wherein the back shell assembly further comprises:
first standoffs constructed and arranged to urge a flange of the first connector into abutment with the first front wall of the first back shell when the first back shell fits around the portion of the first connector and the first standoffs are inserted between the first front wall and the first rear section of the first back shell; and
second standoffs constructed and arranged to urge a flange of the second connector into abutment with the second front wall of the second back shell when the second back shell fits around the portion of the second connector and the second standoffs are inserted between the second front wall and the second rear section of the second back shell.

16. The back shell assembly of claim 15, wherein the first standoffs define first bores;
wherein the second standoffs define second bores; and
wherein the back shell assembly further comprises:
first threaded members constructed and arranged to extend through the first bores defined by the first standoffs to fasten the first back shell to equipment; and
second threaded members constructed and arranged to extend through the second bores defined by the second standoffs to fasten the second back shell to the equipment.

17. The back shell assembly of claim 16, wherein the first standoffs further define internal threads to engage with the first threaded members; and
wherein the second standoffs further define internal threads to engage with the second threaded members.

18. The back shell assembly of claim 11, wherein the first back shell and the second back shell are constructed and arranged to define a stacked connector space when the hardware fastens the first back shell and the second back shell together; and
wherein the first connector and the second connector are positioned one atop the other together in a stacked connector configuration when the first and second connectors populate the stacked connector space.

19. The back shell assembly of claim 18, wherein, when the first and second connectors populate the stacked connector space, the first back shell shields a top and two sides of the first connector and the second back shell shields a bottom and two sides of the second connector leaving a bottom of the first connector and a top of the second connector unshielded relative to each other.

20. A method of assembling an electronic connection apparatus, the method comprising:
fitting a first back shell around a portion of a first connector;
fitting a second back shell around a portion of a second connector; and
installing hardware to fasten the first back shell and the second back shell together, the first back shell and the second back shell providing electromagnetic interference (EMI) shielding to the first connector and the second connector when the first back shell is fit around the portion of the first connector, the second back shell is fit around the portion of the second connector, and the hardware fastens the first back shell and the second back shell together.
